(19) United States
(12) Patent Application Publication
(10) Pub. No.: US 2013/0140359 A1
(43) Pub. Date: Jun. 6, 2013

(54) Method and System of Sending Information Based on a User Card

(71) Applicants: Rongsheng Xie, Hangzhou (CN); Jie Zhang, Hangzhou (CN); Zhenyu Qian, Hangzhou (CN); Chengxian Fan, Hangzhou (CN)

(72) Inventors: Rongsheng Xie, Hangzhou (CN); Jie Zhang, Hangzhou (CN); Zhenyu Qian, Hangzhou (CN); Chengxian Fan, Hangzhou (CN)

(73) Assignee: ALIBABA GROUP HOLDING LIMITED, Grand Cayman (KY)

(21) Appl. No.: 13/320,720

(22) PCT Filed: Aug. 12, 2011
(86) PCT No.: PCT/US11/47638

§ 371 Date: Nov. 15, 2011

(30) Foreign Application Priority Data
Aug. 20, 2010 (CN) 201010264226.4

(51) Int. Cl. G06F 17/30

(52) U.S. Cl. CPC G06F 17/30002
USPC 235/380

(57) ABSTRACT

Sending information based on a user card includes obtaining, by a card terminal, identification information of the user card and sending identification information of the user card and identification information of the card terminal to a device, such as a data analysis and recommendation device. The data analysis and recommendation device determines whether recommendation information corresponding to the identification information of the user card and the identification information of the card terminal exists according to the identification information of the user card and the identification information of the card terminal, and if yes, sends the recommendation information to the card terminal. The data analysis and recommendation device can send the recommendation information to the card terminal and the card terminal can display the information to the user. As the recommendation information may be in different forms, personalized multimedia information can be provided to the user.

### CROSS REFERENCE TO RELATED PATENT APPLICATIONS

This application is a national stage application of an international patent application PCT/US11/47638, filed Aug. 12, 2011, which claims priority to Chinese Patent Application No. 201010264226.4, filed on Aug. 20, 2010, entitled “Method and System of Sending Information Based on a User Card,” which applications are hereby incorporated by reference in their entirety.

### TECHNICAL FIELD

The present disclosure relates to the field of network technology and, more specifically, to a method and a system of sending information based on user cards.

### BACKGROUND

Recently, the Internet of Things has become popular as an innovative technology. The Internet of Things is a network extended and expanded based on Internet, and can connect everything to the Internet through Radio-Frequency Identification (RFID) readers, infrared sensors, Global Positioning System (GPS), laser scanners, etc., based on agreed protocols to exchange and communicate information. Therefore, intelligent identification, position, trace, monitor, and management can be achieved accordingly and user terminals extend and expand to connections between any objects.

Currently, the Internet of Things is mainly used in scanning user cards. User cards include Magnetic Cards, contact Integrated Circuit (IC) cards, contactless cards, etc.

The Magnetic Cards use a liquid magnetic material or a magnetic strip as information carrier by coating liquid magnetic material on the cards (e.g., deposit books) or sticking a magnetic strip (e.g., having a 614 millimeter width) on the cards.

The Contact IC Cards are also called “IC cards,” and include an IC that is a standard serial EEPROM (Electrically Erasable Programmable Read-Only Memory).

Contactless cards are new intelligent cards, which have the same functions as Contact IC Card or IC cards, and are composed of IC chips and an antenna packaged in a standard PVC (Permanence Virtual Circuit) card. The IC chips and the antenna are not exposed at all. Contactless cards require no power source and are powered by electricity magnetically induced from a card reader by the antenna in order to process the data and to feedback to the card reader.

Scanning of user cards includes recognition and identification of the contact or contactless cards. The contactless cards are sometime also called RFID cards. The contactless cards need to be placed near the surface of the card reader and complete the read-write operations through the transmission of wireless electricity.

A card terminal is required to implement the scanning of the user card. The card terminal is a multi-function terminal. By installing card terminals in and connecting them with computers of shops and sale agencies that accept credit card payment and forming a network, financial services, multimedia access display, information publications and other functions can be achieved.

While sent to users from a card terminal, the multimedia information (for example, the multimedia advertisement, etc.) can be published in two different ways: Multimedia Broadcast and Multimedia on Demand (MOD). The multimedia information is preset. Therefore, it is sent to the public instead of to individual people. If the multimedia information sent by the card terminal is not interesting to the users, the multimedia information resource is wasted and the users' experience is poor.

### SUMMARY

The present disclosure introduces a method and a system of sending information based on a user card. A card terminal can be triggered by a user card and provide the personalized information to the user.

To accomplish the purposes above, the present disclosure introduces example systems for sending information based on a user card.

In an example system, a card terminal obtains identification information of a user card, and sends identification information of the user card and identification information of the card terminal to a device, such as a data analysis and recommendation device. The data analysis and recommendation device determines whether recommendation information corresponding to the identification information of the user card and the identification information of the card terminal exists according to the identification information of the user card and the identification information of the card terminal. If the recommendation information does exits, the data analysis and recommendation device sends the recommendation information to the card terminal.

In another example system, a card terminal obtains identification information of a user card, and sends identification information of the user card and identification information of the card terminal to a device, such as a user card management device and a card terminal management device. The user card management device stores the identification information of the user card and corresponding user information, and obtains the user information according to the identification information of the user card sent by the card terminal. The card terminal management device stores identification information of the card terminal and corresponding card terminal information, and obtains the card terminal information according to the identification information of the card terminal. According to the user information obtained by the user card management device and the card terminal information obtained by the card terminal management device, a data analysis and recommendation device determines whether recommendation information corresponding to the user information and the card terminal information exists. If the recommendation information does exit, the data analysis and recommendation device sends the recommendation information to an address or equipment corresponding to the user information.

In another example system, a card terminal obtains identification information of a user card, and sends identification information of the user card and identification information of the card terminal to a device, such as a user card management device, card terminal management device. The user card management device stores user information and the identification information of the user card corresponding to the user information, and obtains the user information according to the identification information of the user card sent by the card terminal. The card terminal management device stores card terminal information and identification information of the card terminal corresponding to the card terminal information, and obtains the card terminal information according to the identification information of the card terminal. According to the user information obtained by the user card management device and the card terminal information obtained by the card terminal management device, a data analysis and recommendation device determines whether recommendation information corresponding to the user information and the card terminal information exists. If the recommendation information does exits, the data analysis and recommendation device sends the recommendation information to an address or equipment corresponding to the card terminal information.

To accomplish the purposes above, the present disclosure introduces example methods of sending information based on a user card.

In an example method, a card terminal obtains identification information of a user card and sends identification information of the user card and identification information of the card terminal to a device, such as a data analysis and recommendation device. The data analysis and recommendation device determines whether recommendation information corresponding to the identification information of the user card and the identification information of the card terminal exists according to the identification information of the user card and the identification information of the card terminal. If the recommendation exists, the data analysis and recommendation device sends the recommendation information to the card terminal.

In another example method, a card terminal obtains identification information of the user card, and sends identification information of the user card and identification information of the card terminal to a device, such as a user card management device and a card terminal management device. The user card management device obtains corresponding user information according to pre-stored identification information of the user card and corresponding user information, and the identification information of the user card sent by the card terminal. The card terminal management device obtains corresponding card terminal information according to pre-stored identification information of the card terminal and corresponding card terminal information. According to the user information obtained by the user card management device and the card terminal information obtained by the card terminal management device, a data analysis and recommendation device determines whether recommendation information corresponding to the user information and the card terminal information exists. If the recommendation information does exits, the data analysis and recommendation device sends the recommendation information to an address or equipment corresponding to the user information.

The present disclosure has the following advantages. The data analysis and recommendation device can send the recommendation information to the card terminal that can display the information to the user. The information displayed to the user varies according to different recommendation information. As the recommendation information may be in different forms, such as advertisement information, text information, picture information, video information, etc., personalized multimedia information can be provided to users.

### DESCRIPTION OF DRAWINGS

FIG. 1 is a diagram of a system structure for sending information based on a user card in accordance with Embodiment 1 of the present disclosure.

FIG. 2 is a schematic diagram of a system structure for sending information based on a user card in accordance with Embodiment 2 of the present disclosure.

FIG. 3 is a schematic diagram of a system structure for sending information based on a user card in accordance with Embodiment 3 of the present disclosure.

FIG. 4 is a schematic diagram of a structure of a card terminal in accordance with Embodiment 5 of the present disclosure.

FIG. 5 is a flowchart of sending information based on a user card in accordance with Embodiment 6 of the present disclosure.

FIG. 6 is a flowchart of sending information based on a user card in accordance with Embodiment 7 of the present disclosure.

FIG. 7 is a flowchart of sending information based on a user card in accordance with Embodiment 8 of the present disclosure.

### DETAILED DESCRIPTION

The embodiments of the present disclosure provide a method and a system of sending information based on a user card. When a user triggers a card terminal through a user card, the card terminal obtains the identification information of the user card, and sends the identification information of the user card and the identification information of the card terminal to a device, such as an analysis and recommendation device. The data analysis and recommendation device determines whether recommendation information corresponding to the identification information of the user card and the identification information of the card terminal exists according to the identification information of the user card and the identification information of the card terminal, and if the determination result is “yes”, sends the recommendation information to the card terminal. Eventually the recommendation information is displayed to the user. Accordingly, personalized information can be provided to different users.

Further description of the present disclosure is given in details in conjunction with the drawings in order to allow a person skilled in the art to understand the technical solutions of the embodiments of the present disclosure. The described embodiments are merely some of the embodiments instead of all the embodiments of the present disclosures. The other possible embodiments obtained by persons skilled in the art with reference to the embodiments given in the present disclosure fall into the scope of protection of the present disclosure.

### Embodiment 1

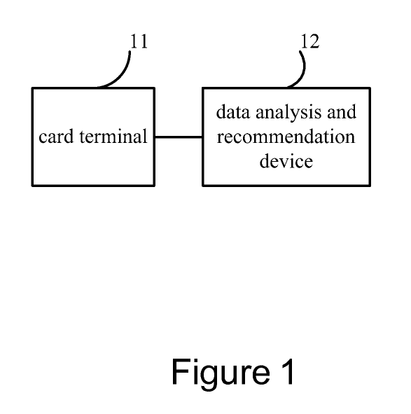

FIG. 1 illustrates a schematic diagram of a system structure for sending information based on a user card in accordance with Embodiment 1. The system includes a card terminal 11 and a data analysis and recommendation device 12.

The card terminal 11 is configured to obtain identification information of a user card, and send the identification information of the user card and identification information of the card terminal. The card terminal includes, but is not limited to, a Point of Sale (POS) machine.

User cards can store the identification information of the user cards. In example applications, each user card has its unique identification information. The identification information of the each user card can be shown in different ways as long as user cards can be distinguished from each other. For example, identification information of a user card can be information of a number of the user card or unique identification information of the user card. The identification information may include, but is not limited to, a user account number, login information and a number of ID card issued by governmental entities.

Identification information of a card terminal can be unique information for determining the card terminal, for example, a serial number or address information of the card terminal, etc.

In the present disclosure, content displayed in a card terminal is available only to a limited number of people, usually only to the person who operates scanning. Accordingly, because multimedia information is generated for and displayed to the public, using conventional technologies to display the multimedia information causes some problems, such as wasting of multimedia information resources and poor user experience.

To solve the problems above, the present disclosure displays personalized information to a user who may be interested in the personalized information that is sent through a card terminal and is displayed in multimedia.

To accomplish the aforementioned goal, when a user operates the scanning at a card terminal, the card terminal reads identification information of the user card that is stored in the user card, and sends out the identification information of the user card. The card terminal also stores identification information of the card terminal, and sends out the identification information of the card terminal.

In example applications, a card terminal can send the identification information of a user card and identification information of the card terminal to the same backend device or different backend devices. In this embodiment, for the purpose of illustration, the identification information of the user card and the identification information of the card terminal are sent by the card terminal to a data analysis and recommendation device.

Specifically, the card terminal can send the identification information of the user card and the identification information of the card terminal to the data analysis and recommendation device through a transmission network. The transmission network includes, but is not limited to, a wire network (e.g., a dialing network) or a wireless network (for example, General Packet Radio Services (GPRS), Code Division Multiple Access (CDMA), Time Division Synchronous Code Division Multiple Access (TD-SCDMA), Wireless Fidelity (WiFi), etc.). The transmission network can adopt Secure Socket Layer (SSL) to encrypt the transmission and secure the transmission.

The data analysis and recommendation device 12 is configured to determine whether recommendation information corresponding to the identification information of the user card and the identification information of the card terminal exists according to the identification information of the user card and the identification information of the card terminal. If the recommendation information exits, the data analysis and recommendation device 12 sends the recommendation information to the card terminal.

In example applications, a corresponding relationship between the identification information of the user card as well as the identification information of the card terminal and the recommendation information can be stored in the data analysis and recommendation device 12 or other backend devices. If the corresponding relationship is stored in the other backend devices, the data analysis and recommendation device 12 obtains the relationship from the backend device, and determines whether the recommendation information corresponding to the identification information of the user card and the identification information of the card terminal exists.

For better description, the present disclosure uses an example that the data analysis and recommendation device 12 stores the recommendation information corresponding to the identification information of the user card and the identification information of the card terminal, as shown in Table 1, which presents the corresponding relationship between the identification information of the user card as well as the identification information of the card terminal and the recommendation information.

TABLE 1

| identification | identification | |
|---|---|---|
| information of | information of the card | recommendation |
| the user card | terminal | information |
| Identification 1 | Identification A | Recommendation |
| | | Information 1 |
| Identification 1 | Identification B | Recommendation |
| | | Information 2 |
| Identification 2 | Identification A | Recommendation |
| | | Information 3 |

In the present disclosure, after obtaining the identification information of the user card and the identification information of the card terminal, the data analysis and recommendation device 12 determine whether the recommendation information corresponding to the identification information of the user card and the identification information of the card terminal exists by looking up Table 1.

For example, when the data analysis and recommendation device 12 finds that the identification information of the user card is Identification 1, as shown in Table 1, and the identification information of the card terminal is Identification C, the data analysis and recommendation device 12 can determine that the corresponding recommendation information does not exist by referring to Table 1. If the identification information of the user card is Identification 1 and the identification information of the card terminal is Identification B, it can determine that the corresponding recommendation information is Recommendation Information 2 by referring to Table 1. The data analysis and recommendation device 12 then sends Recommendation Information 2 to the card terminal 11.

In the present disclosure, the recommendation information can be chosen according to the example situations. For example, the recommendation information can be, but is not limited to, advertisement information (e.g., the name of a shop, a brief introduction of the shop, and a recommended route from a current position to the shop), text information, picture information, video information, subtitle information, Flash animation information, webpage information, PowerPoint Files (PPT) information, etc.

It should be understood that the present disclosure is not limited to using a table for storing the corresponding relationship. Instead, different ways can be used for storing the relationship. The recommendation information of the corresponding relationship can be obtained according to the user's behavior information, which includes, but is not limited to, consumption behavior information and Internet behavior information. After obtaining the user's behavior information, the information that the user may be interested in can be analyzed according to the user's behavior information and can be used as the recommendation information.

Take the consumption behavior information as an example. If a user card having the Identification 1 always operates the type A consumption through a card terminal having the Identification A, the recommendation information is the multimedia information of the shops that are capable of providing the type A consumption. The corresponding relationship is between Identification 1 as well as Identification A and the multimedia information of the shops that can provide the type A consumption.

Take the Internet behavior information as an example. If a user card having the Identification 1 always operates the type A internet behaviors (for example, the behavior information of browsing, reviewing, commenting, collecting, and sharing the products and/or services through internet) through a card terminal having the Identification A, the recommendation information is the multimedia information of the shops that are capable of providing the type A internet behaviors. The corresponding relationship is between Identification 1 as well as Identification A and the multimedia information of the shops which can provide the type A internet behaviors.

In sum, the data analysis and recommendation device can send recommendation information to the card terminal, and the card terminal can display the information to the user. Conventional technologies can only send multimedia information to the public instead of sending different multimedia information to different people respectively. In contrast, in the present disclosure, since recommendation information can be sent to the card terminal for display to the user, the information displayed to the user varies according to different recommendation information. Furthermore, since the recommendation information corresponds to the identification information of the user card and the identification information of the card terminal, the recommendation information includes personalized information for a specific user. Also, as recommendation information can be in different forms, such as advertisement information, text information, picture information, video information, audio information, etc., personalized multimedia information can be provided to the user.

### Embodiment 2

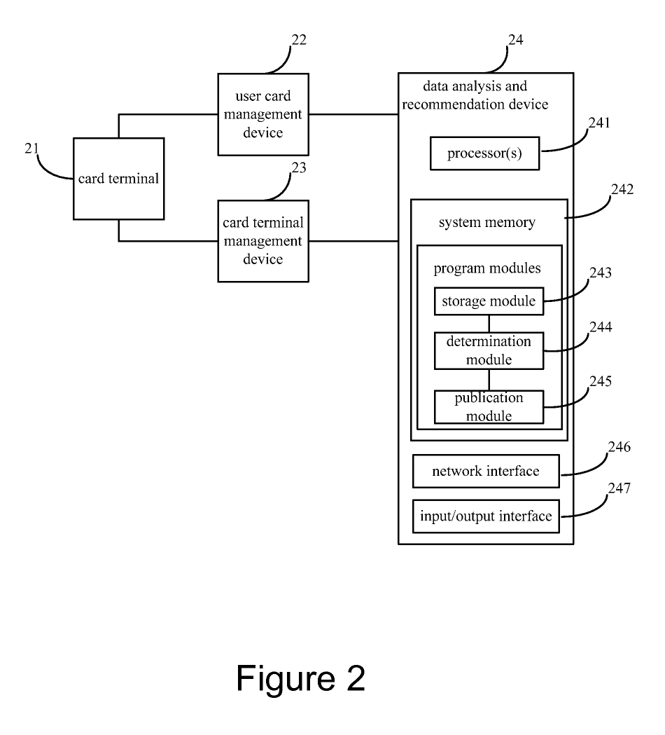

Following Embodiment 1, FIG. 2 illustrates a schematic diagram of a system structure for sending information based on a user card in accordance with Embodiment 2. The system includes a card terminal 21, a user card management device 22, a card terminal management device 23 and a data analysis and recommendation device 24.

The card terminal 21 is configured to obtain identification information of a user card and to send identification information of the user card as well as identification information of the card terminal. The card terminal includes, but is not limited to, a POS machine.

User cards can store the identification information of the user cards. In example applications, each user card has its unique identification information. The identification information of the each user card can be shown in different ways as long as user cards can be distinguished from each other. Other examples of identification information of the user card are not described in details in the present disclosure.

The identification information of the user card can be the only information to determine the user card. For example, the identification information of the user card can be number information or unique identification information. The identification information of the card terminal can be the only information to determine the card terminal 21, for example, the serial number or the address information of the card terminal, etc.

In the present disclosure, when the user operates scanning at the card terminal 21, the card terminal 21 reads the identification information of the user card that is stored in the user card, and sends the identification information of the user card. Additionally, the card terminal 21 stores the identification information of the card terminal 21 and sends the identification information of the card terminal 21.

In example applications, the card terminal 21 can send the identification information of the user card and the identification information of the card terminal 21 to the same backend device or different backend devices. In this embodiment, for the purpose of illustration, the card terminal 21 sends the identification information of the user card to the user card management device 22 and sends the identification information of the card terminal 21 to the card terminal management device 23. In example applications, the functions of the user card management device 22 and the card terminal management device 23 can be integrated into single equipment.

The user card management device 22 is configured to store the identification information of the user card and user information corresponding to the identification information of the user card, and to obtain the corresponding user information based on the identification information of the user card sent by the card terminal 21.

The user information includes, but is not limited to, mobile phone numbers, email addresses, instant message accounts or boxes, micro-blog information, information of the user's friends, user's group information, etc. The information of the user's friends includes, but is not limited to, mobile phone numbers, email addresses, instant message accounts or boxes, micro-blog information, etc. Of course, in example applications, the user's information and the information of the user's friends are not limited to the aforementioned information. All information capable of reaching the user falls into the scope of protection of the present disclosure.

Specifically, the user card management device 22 pre-stores the identification information of the user card and user information corresponding to the identification information of the user card. As the identification information of the user card is unique, the identification information of the user card, as obtained, can be used to obtain the corresponding user information.

The present disclosure presents an example of storing the identification information of the user card and the corresponding user information in the user card management device 22. In example applications, the user card management device 22 can obtain the user information in different ways, which are not limited to obtaining the information from the user card management device 22 according to the identification information of the user card.

For example, the user information can be stored in the user card in example applications. Under such circumstances, the user card management device 22 can obtain, directly from the user card, the user information corresponding to the user card.

For example, in order to save storage space of the user card management device 22, in example applications, the information recorded in the user card management device 22 (for example, the identification information of the user card and the user information) can be stored in a database server. Only information recorded within a preset period (for example, a week) is remained in the user card management device 22. In such situation, as the user card management device 22 does not have the complete user information, it can obtain the user information corresponding to the identification information of the user card from the database server according to the requirements. The method of obtaining the user information from the database server is similar to the method of obtaining the user information from the user card management device 22 and the details are omitted here.

In the present disclosure, in order to provide better services for the user, different types of services may be provided for different users in the user card management device 22. The services include, but are not limited to, membership, friends, transactions, rewards, card management, etc.

The service of membership includes providing the applications of membership, setting the mobile phone and the mail box, certifying the membership, etc. in the user card management device 22.

The service of friends includes providing the information of friends and inquiring the status in the user card management device 22.

The service of transactions includes recording the information of the user's recent behaviors (for example, the consumption behavior information, the internet behavior information, etc.) for a specified time period (the specified time period can be chosen according to the requirements) and querying the user information based on different conditions in the user card management device 22.

The service of rewards include redeeming rewards for gifts, delivering gifts, presenting gifts with beautiful pictures and providing brief introductions, etc. in the user card management device 22. Apart from the gifts, the user can also use the coupons when he/she consumes at a merchant shot that has contracted to accept the user card, and the coupons are stored in the user's membership as virtual currency.

The service of card management includes providing personalized cards, issuing cards, activating cards, setting accounts of payments, inquiring status of cards, etc. in the user card management device 22.

The card terminal management device 23 is configured to store the identification information of the card terminal 21 and corresponding card terminal information corresponding to the identification information of the card terminal 21, and to obtain the corresponding card terminal information according to the identification information of the card terminal 21.

The card terminal information includes, but is not limited to, address information of the card terminal, the card terminal's peripheral card terminals (i.e., the peripheral card terminals available to the user who operates scanning), the card terminal's peripheral advertisement broadcasting equipment (i.e., the peripheral advertisement broadcasting equipment available to the user who operates scanning). Of course, in other example applications, the card terminal information is not limited to the aforementioned information. Any address information capable of displaying the recommendation information to the user's equipment can be regarded as the card terminal information.

Specifically, the card terminal management device 23 pre-stores the identification information of the card terminal 21 and card terminal information corresponding to the identification information of the card terminal 21. As the identification information of the card terminal 21 is unique, the identification information of the card terminal 21, as obtained, can be used to obtain the corresponding card terminal information.

The present disclosure presents an example of storing the identification information of the card terminal 21 and the corresponding card terminal information in the card terminal management device 23. In example applications, the card terminal management device 23 can obtain the card terminal information in different ways, which are not limited to obtaining the information from the card terminal management device 23 according to the identification information of the card terminal 21.

For example, the card terminal information can be stored in the card terminal 21 in example applications. Under such circumstances, the card terminal management device 23 can obtain the card terminal information from the card terminal 21 directly.

For example, in order to save the storage space of the card terminal management device 23, in example applications, the information recorded in the card terminal management device 23 (for example, the identification information of the card terminal and the card terminal information) can be stored in a database server. In such situation, the card terminal management device 23 can obtain the card terminal information corresponding to the identification information of the card terminal from the database server.

The data analysis and recommendation device 24 is configured to determine whether recommendation information corresponding to the obtained user information and the card terminal information exists based on the user information obtained by the user card management device 22 and the card terminal information obtained by the card terminal management device 23, and, if the recommendation information exits, to send the recommendation information to an address or an equipment corresponding to the user information.

In example applications, the methods of obtaining the user information and the card terminal information by the data analysis and recommendation device 24 includes, but is not limited to, directly sending, by the card management device 22, the user information to the data analysis and recommendation device 24, and sending, by the card terminal management device 23, the card terminal information to the data analysis and recommendation device 24. Alternatively, when the data analysis and recommendation device 24 receives the trigger commands for obtaining the user information and the card terminal information, the data analysis and recommendation device 24 may directly obtain the user information and/or the card terminal information from the database server. Alternatively, when the data analysis and recommendation device 24 receives the trigger commands of obtaining the user information and the card terminal information, the data analysis and recommendation device 24 may directly obtain the user information from the user card management device 22 and the card terminal information from the card terminal management device 23.

In the present disclosure, the data analysis and recommendation device 24 may comprise, but is not limited to, one or more processor 241, memory 242, a network interface 246 and an input/output interface 247.

The memory 242 may include computer-readable media in the form of volatile memory, such as random-access memory (RAM) and/or non-volatile memory, such as read only memory (ROM) or flash RAM. The memory 242 is an example of computer-readable media.

Computer-readable media includes volatile and non-volatile, removable and non-removable media implemented in any method or technology for storage of information such as computer readable instructions, data structures, program modules, or other data. Computer readable media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 242 may include program modules, such as storage module 243, determination module 244, and publication module 245. The storage module 243 is configured to store the recommendation information corresponding to the user information and the card terminal information.

In example applications, corresponding relationship between the user information as well as the card terminal information and the recommendation information can be stored in backend devices, which can be chosen according to the requirements. In the present disclosure, for example, the corresponding relationship is stored in the storage module 243 of the data analysis and recommendation device 24, as shown in Table 2, which presents the corresponding relationship between the user information as well as the card terminal information and the recommendation information.

TABLE 2

| | Card terminal | Recommendation |
|---|---|---|
| User information | information | information |
| Mobile Phone Number 1 | Card terminal address A | Recommendation |
| | | Information 1 |
| Mobile Phone Number 1 | Card terminal address B | Recommendation |
| | | Information 2 |
| Mobile Phone Number 2 | Card terminal address A | Recommendation |
| | | Information 3 |

In the present disclosure, the recommendation information can be chosen according to real situations and can include, but is not limited to, advertisement information, text information, picture information, video information, subtitle information, Flash animation information, webpage information, slide information, etc.

It should be understood that the present disclosure is not limited to using a table for storing the relationship. Instead, different ways can be used for storing the relationship. The recommendation information of the relationship can be obtained according to the user's behavior information, which includes, but is not limited to, consumption behavior information and internet behavior information. After obtaining the user's behavior information, the information that the user may be interested in can be analyzed according to the user's behavior information and can be used as the recommendation information.

Furthermore, the user card management device 22 stores the user's behavior information. The data analysis and recommendation device 24 can obtain the user's behavior information from the user card management device 22 and use the user's behavior information to analyze the recommendation information in which the user may be interested.

Take consumption behavior information as an example. The corresponding relationship between the identification information of the user card (for example, the user card 1) and the consumption behavior information is stored in the user card management device 22. Whenever the consumption is completed through the user card 1, the consumption behavior is recorded in the user card management device 22. Accordingly, the user card management device 22 can record all consumption behavior information of the user card 1. If the obtained identification information of the user card is the user card 1, all consumption behavior information of the user card 1 can be found in the user card management device 22.

Take Internet behavior information as an example. The corresponding relationship between the identification information of the user card (for example, the user card 1) and the internet behavior information is stored in the user card management device 22. Whenever the internet behavior (for example, browsing, reviewing, commenting, collecting, and sharing the products and/or services through internet) is completed through the user card 1, the internet behavior is recorded in the user card management device 22. Accordingly, the user card management device 22 can record all internet behavior information of the user card 1. If the obtained identification information of the user card is the user card 1, all internet behavior information of the user card 1 can be found in the user card management device 22.

The determination module 244 is configured to determine whether the recommendation information corresponding to the user information and the card terminal information exists in the storage module 243 according to the user information obtained by the user card management device 22 and the card terminal information obtained by the card terminal management device 23, and, if the recommendation information exists, to trigger a publication module 245.

In the present disclosure, when the data analysis and recommendation device 24 obtains the user information and the card terminal information, the determination module 244 can determine whether the recommendation information corresponding to the user information and the card terminal information exists by looking up the relationships shown in Table 2, and can trigger the publication module 245 after finding the recommendation information.

The publication module 245 is configured to publish the recommendation information to the address or the equipment corresponding to the user information.

For example, if the user information is a mobile phone number, the publication module 245 can directly publish the recommendation information to the equipment corresponding to the mobile phone number (i.e., the mobile phone terminal), and the user perceives the recommendation information through the mobile phone terminal. If the user information is an email address, the publication module 245 can directly publish the recommendation information to the email address, and the user perceives the recommendation information through the email address. Other user information is omitted in the present disclosure.

It should be understood that in example applications, after knowing the recommendation information that the user is interested in, as many shops can provide the same or the similar services, the data analysis and recommendation device 24 obtains the list of recommendation information that the user is interested in (the list contains the information of many shops) and selects one or more pieces of recommendation information that matches the card terminal 21 from the list of recommendation information according to the location of the card terminal 21 (for example, the shop being closest to the card terminal or the shop being close to the card terminal and currently popular).

In the present disclosure, in order to enhance the user's experience, the recommendation information is sent to the address or the equipment corresponding to the user information in the form of multimedia and is displayed to the user through the address or the equipment corresponding to the user information.

Therefore, the recommendation information can also be multimedia information corresponding to the shops. The multimedia information can be stored in the storage module 243, which can be constituted by disk arrays. The multimedia information can be directly obtained from the storage module 243.

Specifically, the storage module 243 can store the corresponding relationship between the identification of a shop (for example, the shop's name, the shop's unique number, etc.) and the multimedia information of the shop. If the multimedia information corresponding to the shop is requested, the corresponding identification of the shop is determined first, the multimedia information, as the recommendation information, can be obtained according to the identification.

Further, it should understood that in order to store the multimedia information of each shop in the storage module 243, the data analysis and recommendation device 24 can obtain information of each shop, edit the information, transform the information into the multimedia information, and store the multimedia information in the storage module 243.

Specifically, in order to make sure that the storage module 243 can store the multimedia information of each shop, the data analysis and recommendation device 24 can obtain the information of each shop (for example, text information, picture information, audio information, video information, etc.), edit the information, and transform the information into the multimedia information.

In example applications, in order to find the necessary multimedia information from the storage device, the data analysis and recommendation device 24 can categorize the multimedia information of each shop and store the categorized multimedia information in the storage module 243. For example, the multimedia information corresponding to the shops that can provide the service of type A is stored as Group 1 in the storage module 243, and the multimedia information corresponding to the shops that can provide the service of type B is stored as Group 2 in the storage module 243. If the recommendation information to be displayed to the user refers to the shops providing the service of type A, the data analysis and recommendation device 24 only needs to look up Group 1 to find the multimedia information corresponding to all the shops that can provide the service of type A. Then, the multimedia information corresponding to these shops can be found, and finally the recommendation information can be obtained.

In sum, the recommendation information can be sent to the address or the equipment corresponding to the user information through the publication module 245 of the data analysis and recommendation device, and can be displayed to the user via the address or the equipment corresponding to the user information. Compared with the conventional technology which can only send multimedia information to the public instead of sending different multimedia information to different people respectively, in the present disclosure, as the recommendation information can be sent to the address or the equipment corresponding to the user information for display, the information displayed to the user varies according to the different recommendation information. Furthermore, as the recommendation information corresponds to the user information and the card terminal information, the recommendation information is personalized information for a specific user. Also, as the recommendation information can be in different forms, such as advertisement information, text information, picture information, video information, audio information, etc., personalized multimedia information can be provided to the user.

### Embodiment 3

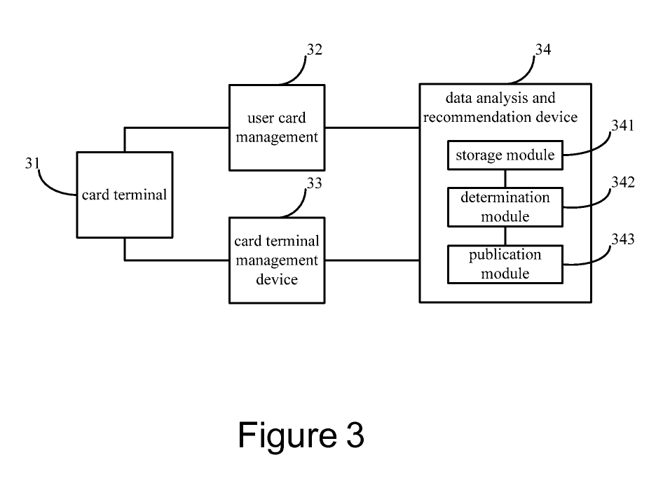

Following Embodiment 2, FIG. 3 illustrates a schematic diagram of a system structure for sending information based on a user card in accordance with Embodiment 3. The system includes a card terminal 31, a user card management device 32, a card terminal management device 33 and a data analysis and recommendation device 34.

The card terminal 31 is configured to obtain identification information of a user card, and to send identification information of the user card as well as identification information of the card terminal. The card terminal includes, but is not limited to, a POS machine.

The identification information of the user card can be the only information used to determine the user card. For example, the identification information of the user card can be number information, or unique identification information. Additionally or alternatively, the identification information of the card terminal can be the only information used to determine the card terminal, for example, the serial number or the address information of the card terminal, etc.

In the present disclosure, when the user operates scanning at the card terminal 31, the card terminal 31 reads the identification information of the user card that is stored in the user card, and sends the identification information of the user card. Additionally, the card terminal 31 stores the identification information of the card terminal 31, and sends the identification information of the card terminal 31 to the card terminal management device 33.

The user card management device 32 is configured to store user information and the identification information of the user card corresponding to the user information, and to obtain the corresponding user information based on the identification information of the user card sent by the card terminal 31.

The user information includes, but is not limited to, mobile phone numbers, email addresses, instant message accounts or boxes, micro-blog information, information of the user's friends, user's group information, etc. The information of the user's friends includes, but is not limited to, mobile phone numbers, email addresses, MSN accounts, micro-blog information, etc.

The card terminal management device 33 is configured to store the card terminal information and the identification information of the card terminal corresponding to the card terminal information, and to obtain the corresponding card terminal information according to the identification information of the card terminal.

The card terminal information includes, but is not limited to, the address information of the card terminal, the card terminal's peripheral card terminals and the card terminal's peripheral advertisement broadcasting equipments.

The data analysis and recommendation device 34 is configured to determine whether recommendation information corresponding to the obtained user information and the card terminal information exists based on the user information obtained by the user card management device 32 and the card terminal information obtained by the card terminal management device 33, and, if the recommendation information exists, to send the recommendation information to an address or an equipment corresponding to the user information.

In the present disclosure, the data analysis and recommendation device 34 further comprise the following modules.

The storage module 341 is configured to store the recommendation information corresponding to the user information and the card terminal information.

In the present disclosure, the recommendation information can be chosen according to real situations and can include, but is not limited to, advertisement information, text information, picture information, video information, subtitle information, Flash animation information, webpage information, slide information, etc.

The determination module 342 is configured to determine whether the recommendation information corresponding to the user information and the card terminal information exists in the storage module 341 according to the user information obtained by the user card management device 32 and the card terminal information obtained by the card terminal management device 33, and, if the recommendation information exits, to trigger a publication module 343.

The publication module 343 is configured to publish the recommendation information to the address or the equipment corresponding to the user information.

For example, if the card terminal information is the address information of the card terminal, the publication module 343 can directly publish the recommendation information to the card terminal 31, which displays the recommendation information to the user. If the card terminal information is the address information of a peripheral advertisement broadcasting equipment, the peripheral advertisement broadcasting equipment displays the recommendation information to the user. Other card terminal information is omitted in the present disclosure.

In the present disclosure, in order to enhance the user's experience, the recommendation information is sent to the address or the equipment corresponding to the card terminal information in the form of multimedia and is displayed to the user through the address or the equipment corresponding to the card terminal information.

In sum, the recommendation information can be sent to the address or the equipment corresponding to the card terminal information through the publication module 343 of the data analysis and recommendation device, and can be displayed to the user via the address or the equipment corresponding to the card terminal information. Compared with the conventional technology which can only send multimedia information to the public instead of sending different multimedia information to different people respectively, in the present disclosure, since the recommendation information can be sent to the address or the equipment corresponding to the card terminal information for display, the information displayed to the user varies according to the different recommendation information. Furthermore, since the recommendation information corresponds to the user information and the card terminal information, the recommendation information is personalized information for a specific user. Also, since the recommendation information can be in different forms, such as advertisement information, text information, picture information, video information, audio information, etc., personalized multimedia information can be provided to the user.

### Embodiment 4

Following Embodiment 3, Embodiment 4 provides a device for sending information based on a user card. After displaying the recommended information to the user, the card terminal can further receive a trigger command, which indicates that the user has selected the recommended information. In the present embodiment, the user information includes the information of the user's friends, for example, mobile phone numbers, email addresses, MSN accounts, micro-blog information, etc. The user card management device can store the corresponding relationship between the identification information of the user card and the information of the user's friends. After obtaining the identification information of the user card, the user card management device can further obtain the information of the user's friends based on the identification information of the user card.

After obtaining the information of the user's friends, the recommendation information can be sent to the address or the equipment corresponding to the information of the user's friends. The sending method is similar to the method of sending the recommendation information to the address or the equipment corresponding to the user information, as described in Embodiment 2. The details are omitted in this embodiment.

Furthermore, it should be understood that in example applications, after displaying the recommendation information to the user, the user can evaluate the recommendation information (e.g., Recommendation Information 1 in Table 1). If the evaluation result is better than a preset grade, Recommendation Information 1 will have priority over others that have lower grades when the recommendation information is sent to the user in the future; if the evaluation result is worse than a preset grade, the Recommendation Information 1 will not be chosen when the recommendation information is sent to the user in the future. Details are omitted here.

In sum, sending the recommendation information to the address or the equipment corresponding to the user information enables the recommendation information to be displayed to the user; sending the recommendation information to the address or the equipment corresponding to the information of the user's friends enables the recommendation information to be displayed to the user's friends. Compared with the conventional technology that can only send multimedia information to the public instead of sending different multimedia information to different people respectively, in the present disclosure, as the recommendation information can be sent to the address or the equipment corresponding to the information of the user's friends for display, the information displayed to the user varies according to different recommendation information. Furthermore, as the recommendation information corresponds to the user information and the card terminal information, the recommendation information is personalized information for a specific user. Also, as the recommendation information can be in different forms, such as advertisement information, text information, picture information, video information, audio information, etc., personalized multimedia information can be provided to the user. In addition, displaying the recommendation information to the user's friend through the address or the equipment corresponding to the information of the user's friends solves the problem existing in the conventional technology that the friends cannot easily share relative information.

### Embodiment 5

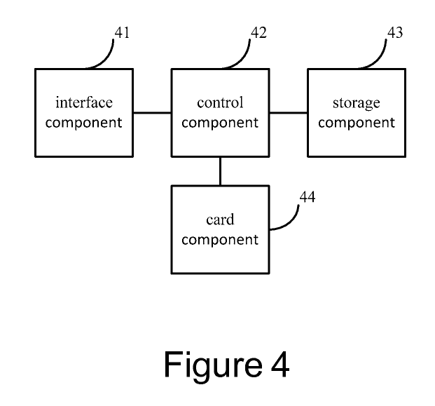

Embodiment 5 provides a card terminal for the systems shown in Embodiments 1-4. As shown in FIG. 4, a diagram of the structure of the card terminal in accordance with Embodiment 5 of the present disclosure is provided. It should be understood that persons skilled in the art can design the corresponding card terminal according to the functions presented in the embodiments of the present disclosure. The present embodiment merely provides a specific example but does not intend to make any limitation to the card terminal.

As shown in FIG. 4, the card terminal includes: an interface component 41 for providing interfaces of each external equipment; a control component 42 for processing and controlling the input/output of the data, for example, the user card data, the graphic data, the recommendation data, etc; a storage component 43, for example the electronic disks (e.g., a SD card, a CF card), for storing data of various card terminals; and a card component 44 for reading and writing the cards.

The interface component 41 can include a network interface for connecting Ethernet, WiFi, etc., exchanging the payment information and the personal information, and downloading certain video information, picture information or text advertisement information.

The interface component 41 can further include serials (for example, 3-wire RS232 serial, etc.) or USB connecting to the external keyboards or touch screens, etc. to support the user of functions such as password logins and touch operations.

The interface component 41 can include an audio/video input/output interface, for example, a Video Graphics Array (VGA) interface, a LVDS interface, a DVI interface, etc. Through an external display device, such as a liquid crystal display, various inquiries or payment information and recommendation information can be displayed.

The control component 42 can be a Micro Control Unit (MCU), which can integrate memory, such as a Random Access Memory (RAM) with capacity no less than 32M, to process the user's inquiries or payments, to download data and to play multimedia.

The control component 42 can also include an audio/video encoding/decoding module to provide sufficient capability of processing the video data, to support various video/audio standards, and to meet the requirements of multimedia applications on IP networks.

The control component 42 can also include a terminal security control module installed in the terminal equipment, such as the shop's POS, network terminals, direct-connection terminals, etc. to control the security of machines.

If the card terminal can store multimedia contents in the storage component 43, the contents can be locally loaded when the contents are considered as the recommendation information. Therefore, redundant downloading and occupations of network bandwidths can be avoided.

The card component 44 can be a RFID card reader 261 for reading/writing cards compatible with, for example, 125K ID, 13.56 MHz ISO/IEC15693, ISO/IEC14443, 900M ISO/IEC18000-6C.

The card component 44 can also be a magnetic card reader for the bi-directional scanning.

Additionally, the card terminal can further be connected to the external equipment such as a printer through the interface component 41.

### Embodiment 6

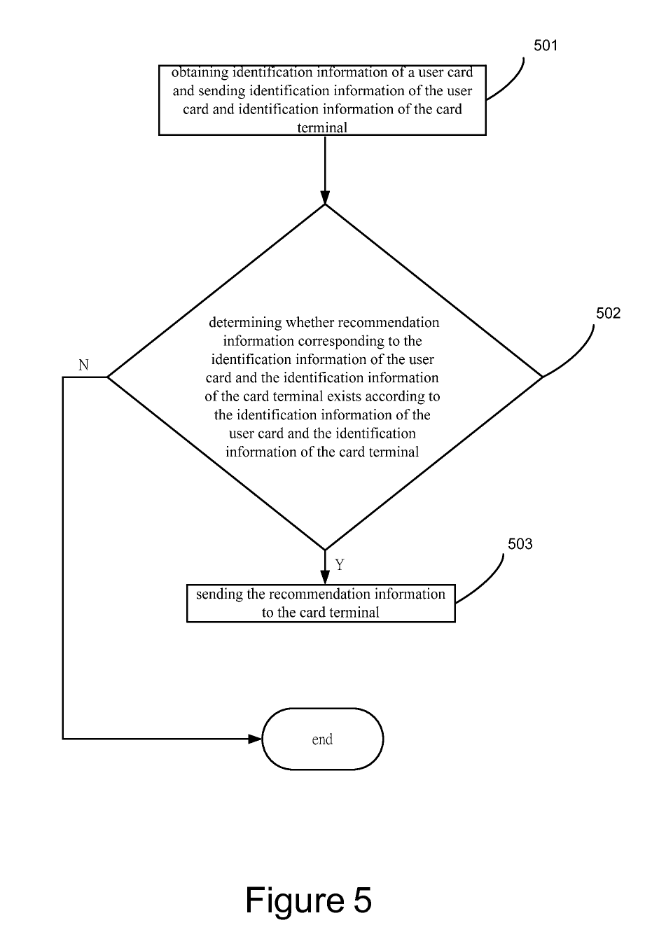

As shown in FIG. 5, a flowchart of sending information based on a user card in accordance with Embodiment 6 of the present disclosure, which corresponds to the system and the applications disclosed in Embodiment 1, is provided. At operation 501, a card terminal obtains identification information of a user card and sends identification information of the user card and identification information of the card terminal. The card terminal sends identification information of the user card and identification information of the card terminal to a data analysis and recommendation device.

At operation 502, the data analysis and recommendation device determines whether recommendation information corresponding to the identification information of the user card and the identification information of the card terminal exists according to the identification information of the user card and the identification information of the card terminal. If the recommendation information does exist, the data analysis and recommendation device sends the recommendation information to the card terminal, as shown at operation 503.

### Embodiment 7

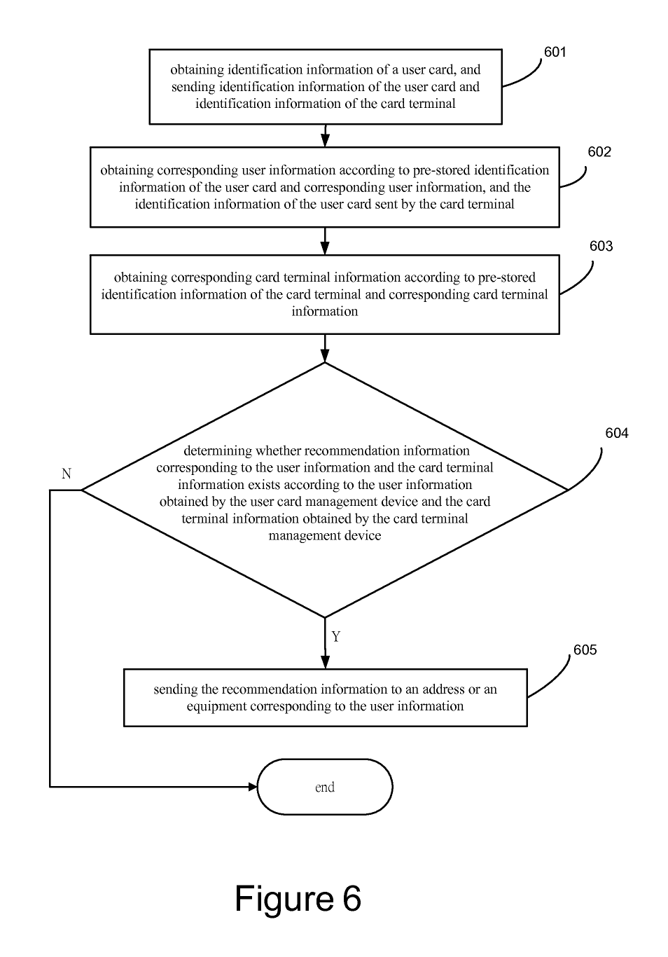

As shown in FIG. 6, a flowchart of sending information based on a user card in accordance with Embodiment 7 of the present disclosure, which corresponds to the system and the applications disclosed in Embodiment 2, is provided. At operation 601, a card terminal obtains identification information of a user card, and sends identification information of the user card and identification information of the card terminal. The card terminal sends identification information of the user card to a user card management device and identification information of the card terminal to a card terminal management device.

At operation 602, the user card management device obtains corresponding user information according to pre-stored identification information of the user card and corresponding user information, and the identification information of the user card sent by the card terminal. The user card management device needs to send the user information to a data analysis and recommendation device afterwards. At operation 603, the card terminal management device obtains corresponding card terminal information according to pre-stored identification information of the card terminal and corresponding card terminal information. The card terminal management sends the card terminal information to a data analysis and recommendation device afterwards. Operations 602 and 603 do not have to be operated sequentially. In other words, the two steps can be operated simultaneously or sequentially.

At operation 604, the data analysis and recommendation device determines whether recommendation information corresponding to the user information and the card terminal information exists according to the user information obtained by the user card management device and the card terminal information obtained by the card terminal management device. The data analysis and recommendation device may determine whether recommendation information corresponding to the obtained user information and the obtained card terminal information exists in recommendation information corresponding to pre-stored user information and pre-stored card terminal information according to the user information obtained by the user card management device and the card terminal information obtained by the card terminal management device. If the recommendation information exits, the analysis and recommendation device sends the recommendation information to an address or equipment corresponding to the user information.

### Embodiment 8

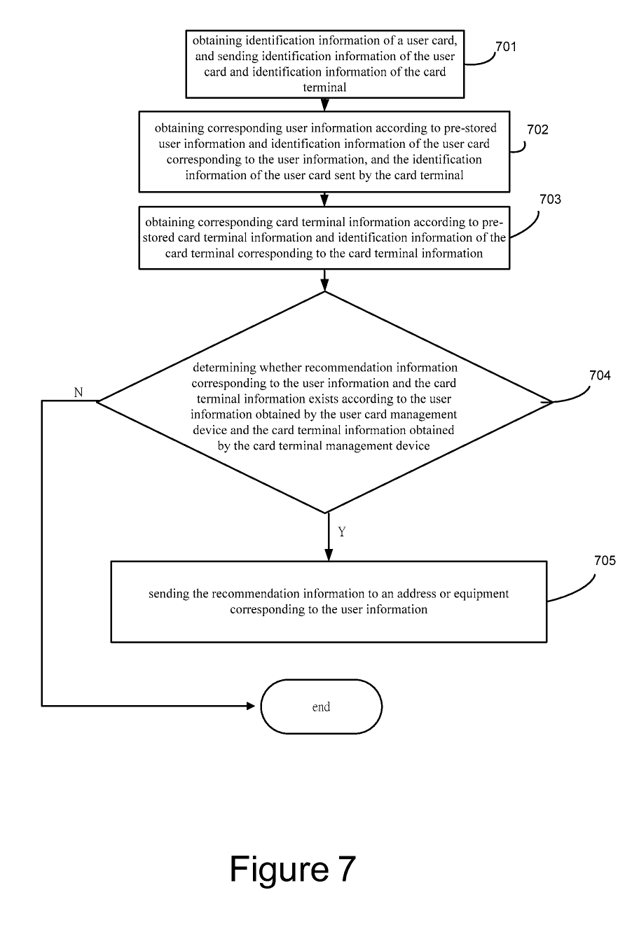

As shown in FIG. 7, a flowchart of sending information based on a user card in accordance with Embodiment 8 of the present disclosure, which corresponds to the system and the applications disclosed in Embodiment 3, is provided. At operation 701, a card terminal obtains identification information of a user card, and sends identification information of the user card and identification information of the card terminal. The card terminal sends identification information of the user card to a user card management device and identification information of the card terminal to a card terminal management device.

At operation 702, the user card management device obtains corresponding user information according to pre-stored user information and identification information of the user card corresponding to the user information, and the identification information of the user card sent by the card terminal. The user card management device sends the user information to a data analysis and recommendation device afterwards. At operation 703, the card terminal management device obtains corresponding card terminal information according to pre-stored card terminal information and identification information of the card terminal corresponding to the card terminal information. The card terminal management sends the card terminal information to a data analysis and recommendation device afterwards. Operations 702 and 703 do not have to be operated sequentially. In other words, the two steps can be operated simultaneously or sequentially.

At operation 704, the data analysis and recommendation device determines whether recommendation information corresponding to the user information and the card terminal information exists according to the user information obtained by the user card management device and the card terminal information obtained by the card terminal management device. The data analysis and recommendation device may determine whether recommendation information corresponding to the obtained user information and the obtained card terminal information exists in recommendation information corresponding to pre-stored user information and pre-stored card terminal information according to the user information obtained by the user card management device and the card terminal information obtained by the card terminal management device. If the recommendation information exits, the data analysis and recommendation device sends the recommendation information to an address or equipment corresponding to the user information.

By reading the above implementations, persons in the technical field could clearly understand that the present disclosure can be implemented by certain software with some necessary general hardware platforms. Based on the understanding, in essence, the technical solution of the present disclosure or the contribution to the conventional technology can be implemented in the form of software products. The computer software products can be saved in memory medium, including certain instructions which can be used to make a computer device (a personal computer, a server, or a network device, etc.) to conduct the methods described in the embodiments or parts of the embodiments of the present disclosure.

The embodiments disclosed herein are merely some preferred implementation of the present disclosure. Persons skilled in the art should understand that although the present disclosure is described in certain embodiments, any changes and modifications to the embodiments without departing the spirits of the present disclosure should be considered as covered by Claims.

Persons in the technical field can understand that the modules can be distributed in the devices of the embodiments or be distributed in one or more devices which are different to the embodiments of the present disclosure. The modules in the embodiments can be integrated or distributed separately. The modules can be integrated as one module or be further divided into multiple sub-modules. The aforementioned embodiments are depicted merely for illustration and do not refer to advantages or disadvantages of the present disclosure.

Although certain specific embodiments are presented, the scope of the present disclosure is not limited to the embodiments. Any changes to the embodiments that persons skilled in the art would think of fall in to the scope of the present disclosure.

What is claimed is:

1. A system for sending information based on a user card, the system comprising:
a card terminal to:
obtain identification information of the user card, and
send identification information of the user card and identification information of the card terminal; and
a data analysis and recommendation device to:
determine whether recommendation information corresponding to the identification information of the user card and the identification information of the card terminal exists based on the identification information of the user card and the identification information of the card terminal that are sent by the card terminal, and
if the recommendation information corresponding to the identification information of the user card and the identification information of the card terminal exists, send the recommendation information to the card terminal.

2. The system as recited in claim 1, wherein the identification information of the user card comprises at least one of a number of the user card and/or unique identification of the user card.

3. The system as recited in claim 1, wherein the identification information of the card terminal comprises at least one of serial number of the card terminal and/or address information of the card terminal.

4. The system as recited in claim 1, wherein the recommendation information comprises at least one of advertisements, text, pictures, videos, subtitles, Flash animations, WebPages, and/or PowerPoint files.

5. The system as recited in claim 1, wherein the card terminal comprises at least one of Radio-Frequency Identification (RFID) readers, infrared sensors, Global Positioning System (GPS), and/or laser scanners.

6. The system as recited in claim 1, wherein the user card comprises a Magnetic Card, a contact Integrated Circuit (IC) card, or a Contactless Card.

7. A system for sending information based on a user card, comprising:
a card terminal to:
obtain identification information of the user card, and
send identification information of the user card and identification information of the card terminal;
a user card management device to store the identification information of the user card and user information corresponding to the identification information of the user card, the user information being obtained based on the identification information of the user card sent by the card terminal;
a card terminal management device to store the identification information of the card terminal and card terminal information corresponding to the identification information of the card terminal, the card terminal information being obtained based on the identification information of the card terminal; and
a data analysis and recommendation device to:
determine whether recommendation information corresponding to the user information and the card terminal information exists based on the user information obtained by the user card management device and the card terminal information obtained by the card terminal management device, and
if the recommendation information corresponding to the user information and the card terminal information exits, send the recommendation information to an address or equipment corresponding to the user information.

8. The system as recited in claim 7, wherein the card terminal information comprises at least one of address information of the card terminal, peripheral card terminal information of the card terminal, and/or peripheral advertisement broadcasting equipment information.

9. The system as recited in claim 7, wherein the user terminal comprises an interface component, a control component, a storage component and a card component.

10. The system as recited in claim 7, wherein the data analysis and recommendation device comprises:
a storage module to store the recommendation information corresponding to the user information and the card terminal information;
a determination module to determine whether the recommendation information corresponding to the user information and the card terminal information exists in the storage module based on the user information obtained by the user card management device and the card terminal information obtained by the card terminal management device; and
a publication module to publish, if the recommendation information corresponding to the user information and the card terminal information exists, the recommendation information to the address or the equipment corresponding to the user information.

11. A system for sending information based on a user card, comprising:
a card terminal to:
obtain identification information of the user card, and
send identification information of the user card and identification information of the card terminal;
a user card management device to store user information and the identification information of the user card corresponding to the user information that is obtained based on the identification information of the user card sent by the card terminal;
a card terminal management device to store card terminal information and the identification information of the card terminal corresponding to the card terminal information that is obtained based on the identification information of the card terminal; and
a data analysis and recommendation device to:
determine whether recommendation information corresponding to the user information and the card terminal information exists based on the user information obtained by the user card management device and the card terminal information obtained by the card terminal management device, and
if the recommendation information corresponding to the user information and the card terminal information exists, send the recommendation information to an address or an equipment corresponding to the card terminal information.

12. The system as recited in claim 11, wherein the data analysis and recommendation device comprises:
a storage module to store the recommendation information corresponding to the user information and the card terminal information;
a determination module to determine whether the recommendation information corresponding to the user information and the card terminal information exists in the storage module based on the user information obtained by the user card management device and the card terminal information obtained by the card terminal management device; and
a publication module to publish, if the recommendation information exists, the recommendation information to the address or the equipment corresponding to the card terminal information.

13. A method of sending information based on a user card, comprising:
obtaining, by a card terminal, identification information of the user card;
sending, by a card terminal, identification information of the user card and identification information of the card terminal;
determining, by a data analysis and recommendation device, whether recommendation information corresponding to the identification information of the user card and the identification information of the card terminal exists based on the identification information of the user card and the identification information of the card terminal; and
if the recommendation information corresponding to the identification information of the user card and the identification information of the card terminal exists, sending the recommendation information to the card terminal.

14. The method as recited in claim 13, wherein the identification information of the user card comprises at least one of a number of the user card and/or unique identification of the user card.

15. The method as recited in claim 13, wherein the identification information of the card terminal comprises at least one of serial number of the card terminal and/or address information of the card terminal.

16. A method of sending information based on a user card, comprising:
obtaining, by a card terminal, identification information of the user card;
sending, by a card terminal, the identification information of the user card and identification information of the card terminal;
obtaining, by a user card management device, user information based on pre-stored identification information of the user card, pre-stored user information corresponding to the pre-stored identification information of the user card, and the identification information of the user card sent by the card terminal;
obtaining, by a card terminal management device, card terminal information based on pre-stored identification information of the card terminal, pre-stored card terminal information corresponding to the pre-stored identification of the card terminal, and the identification information of the card terminal obtained by the card terminal; and
determining, by a data analysis and recommendation device, whether recommendation information corresponding to the user information and the card terminal information exists based on the user information obtained by the user card management device and the card terminal information obtained by the card terminal management device; and
if the recommendation information corresponding to the user information and the card terminal information exists, sending the recommendation information to an address or equipment corresponding to the user information.

17. The method as recited in claim 16, wherein the determining comprises:
determining whether the recommendation information corresponding to the user information and the card terminal information exists in pre-stored recommendation information corresponding to the pre-stored user information and the pre-stored card terminal information based on the user information obtained by the user card management device and the card terminal information obtained by the card terminal management device.

18. A method of sending information based on a user card, comprising:
obtaining, by a card terminal, identification information of the user card;
sending the identification information of the user card and identification information of the card terminal;
obtaining, by a user card management device, user information based on pre-stored user information, pre-stored identification information of the user card corresponding to the pre-stored user information, and the identification information of the user card sent by the card terminal;
obtaining, by a card terminal management device, card terminal information based on pre-stored card terminal information, pre-stored identification information of the card terminal corresponding to the pre-stored card terminal information, and the identification information of the card terminal obtained by the card terminal;
determining, by a data analysis and recommendation device, whether recommendation information corresponding to the user information and the card terminal information exists based on the user information obtained by the user card management device and the card terminal information obtained by the card terminal management device; and
if the recommendation corresponding to the user information and the card terminal information exists, sending the recommendation information to an address or equipment corresponding to the user information.

19. The method as recited in claim 18, wherein the determining comprises:
determining whether the recommendation information corresponding to the user information and the card terminal information exists in pre-stored recommendation information corresponding to the pre-stored user information and pre-stored card terminal information based on the user information obtained by the user card management device and the card terminal information obtained by the card terminal management device.

20. The method as recited in claim 18, wherein the card terminal information comprises at least one of address information of the card terminal, peripheral card terminal information of the card terminal, and/or peripheral advertisement broadcasting equipment information.
